(19) United States
(12) Patent Application Publication
(10) Pub. No.: US 2006/0254121 A1
(43) Pub. Date: Nov. 16, 2006

(54) Two-way sensitive fishing bobber and stop bead for use therewith

(76) Inventor: Minh Tri Huynh, Woodbridge (CA)

Correspondence Address: YOUNG & BASILE, P.C., 3001 WEST BIG BEAVER ROAD, SUITE 624, TROY, MI, 48084, US

(21) Appl. No.: 11/125,938

(22) Filed: May 10, 2005

(51) Int. Cl. A01K 93/00

(52) U.S. Cl. 43/44.95; 43/44.87; 43/44.91

(57) ABSTRACT

A fishing bobber for use with a fishing line terminating in a hook is disclosed. The bobber has a body floatable in water and a pair of elongate arms projecting from opposite sides of the body, said pair comprising a first arm to which said line is secured in use and a second arm. The centre of gravity of said bobber can be adjusted such that, in use and in the absence of external forces, the bobber is balanced so as to float in the water with its arms projecting substantially horizontally, and said hook is suspended by the line a user-selectable depth beneath the body. When a fish applies tension to the line, the bobber tips such that the first arm portion extends downwardly from the body; and when a fish releases tension from the line, the bobber tips such that the first arm extends upwardly from the body.

### BACKGROUND OF THE INVENTION

The present invention relates to the field of angling, and more particularly, to bobber fishing.

Bobber fishing is widely practiced by anglers.

One form of bobber fishing is fixed-bobber fishing. This form involves the use of a bobber or float. The float is fixedly secured to the line of an angler towards the end which holds the hook or bait set. This form of fishing is adequate in some situations, but it has drawbacks. Firstly, the depth at which the hook can be set is more or less limited to the length of the angler's rod; at any deeper setting, it becomes too difficult to cast with distance or accuracy. Secondly, because of the fixed attachment of the line and bobber, the amount of line that can be reeled up is limited, thus hampering efforts to control fish (especially large ones) in the critical time period immediately before the fish has been landed. Yet further, the direct attachment of fixed bobbers can damage lines. Also of significant importance to anglers, fixed bobbers have sensitivity limitations, in that only in circumstances when a fish takes the hook and moves vigorously away from the bobber does the float move vigorously in the water, to alert the angler. This is problematic, because in this circumstance the fish is alerted at the same time the angler is alerted; the fish may react to the tension in the line faster than the angler reacts to the bobber movement, and expel the hook even before the angler has had a chance to set it.

Another form of bobber fishing is slip-bobber fishing, which involves a slip bobber. This is a bobber that slides along the angler's line. Conventional slip bobbers often have a float and a tubular member which extends through the float and through which the line extends. A stop bead (a small bead with a small diameter hole extending therethough) is fitted around the line ahead of the slip bobber. A stop knot is tied around the fishing line at a distance from the hook equal to the desired fishing depth. The stop knot is small enough to pass easily through rod guides but too large to pass through the stop bead. The stop knot is tied tightly enough to resist movement under pressure from the bobber, but can still be moved along the line if the angler desires a new depth setting. Often, a length of elastic band is used to make the stop knot. Conventional slip bobbers solve some of the problems indicated above in association with fixed bobbers: they can be fished at any depth, the line can be reeled all the way to the tackle, and they are not prone to causing line damage. However, conventional slip bobbers are not without drawbacks. Such drawbacks include the friction associated with the passage of the line through the tubular member. This friction has a tendency to draw the float to the angler relatively quickly when agitating the hook, to attract fish. Further, the friction serves to impede the descent of the bait set in the water. When a lightweight bait set is agitated, it tends to rise relatively quickly in the water and descend relatively slowly. This makes it difficult for an angler to create the illusion of a darting bait fish with the bait set. Moreover, slip bobbers continue to suffer from the sensitivity limitations outlined above.

Improvements in the field of fishing bobbers remain of interest.

### SUMMARY OF THE INVENTION

A fishing bobber for use with a fishing line terminating in a hook forms one aspect of the invention. The bobber has a body portion and a pair of elongate arm portions. The body portion is floatable in water. The pair of elongate arm portions project from opposite sides of the body portion and comprises a first arm portion to which said line is secured in use and a second arm portion. The bobber also comprises means for adjusting the centre of gravity of said fishing bobber assembly such that, in use and in the absence of external forces, the fishing bobber is balanced so as to float in the water with the arm portions projecting substantially horizontally therefrom and said hook is suspended by said line a user-selectable depth beneath the body portion. When a fish applies tension to the line, the fishing bobber tips such that the first arm portion extends downwardly from the body portion; and when a fish releases tension from the line, the fishing bobber tips such that the first arm portion extends upwardly from the body portion.

A stop bead for use with a fishing line forms another aspect of the invention. The stop bead comprises a resilient body having an outer surface and defining a passage and a jagged channel. The passage extends through the body, is adapted to receive in throughpassing relation said fishing line, and terminates at opposites sides of the body in passage terminii. The jagged channel extends between the passage terminii and from the outer surface of the body through to the passage, thereby to permit, upon deformation of the body, a fishing line received in the passage in throughpassing relation to be withdrawn from the body otherwise than by way of retraction of said line through said passage.

### BRIEF DESCRIPTION OF THE DRAWINGS

FIG. 1 is a side view of a fixed bobber according to the prior art in use;

FIG. 2 is a side view of a slip bobber according to the prior art in use;

FIG. 3 is a side view of a fishing bobber constructed according to the preferred embodiment of the invention, with portions broken away for clarity as to the details of construction;

FIG. 4 is a side view of the fishing bobber of FIG. 3 in use in a first mode, similar to FIG. 1;

FIG. 5 is a side view of the fishing bobber of FIG. 3 in use in a second mode;

FIG. 6 is a side view of the fishing bobber of FIG. 3 in use in a third mode, the view also showing a stop bead constructed according to the preferred embodiment of the invention; and

FIG. 7 is an enlarged view of the stop bead of FIG. 6, with interior structures shown in phantom outline, for clarity.

### DETAILED DESCRIPTION OF THE PREFERRED EMBODIMENT

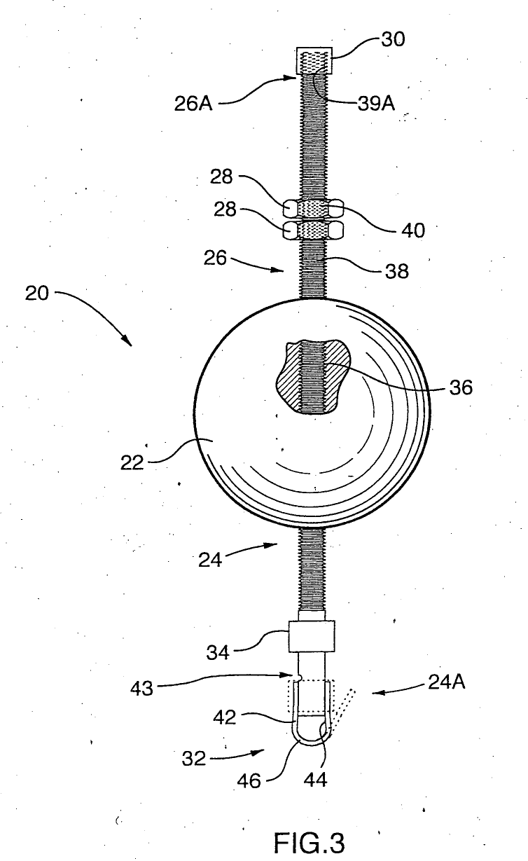

A fishing bobber constructed according to a preferred embodiment of the invention is shown in FIG. 3 and designated with general reference numeral 20.

The bobber 20 comprises a body portion 22, a pair of elongate arm portions 24,26, a weight 28, a cap 30, a clip 32 and a sleeve 34.

The body portion 22 is floatable in water and in the preferred embodiment takes the form of a sphere having a threaded bore 36 defined therethrough. The body portion 22 is constructed out of balsa wood and includes a red half and a white half (not shown).

The pair of arm portions 24,26, which comprise a first arm portion 24 and a second arm portion 26, project from opposite sides of the body portion 22 and are formed integrally as parts of an elongate shaft 24,26 which extends through the body portion 22. A thread 38, defined externally on the elongate shaft 24,26, engages the threaded bore 36 in the body portion 22 such that the shaft 24,26 moves longitudinally with respect to the body portion 22 upon rotation of the shaft 24,26 relative to the body portion 22. The first arm portion 24 terminates in arm end 24A, which is coloured green and which is provided with a notch 43. The second arm portion terminates in an arm end 26A.

The weight 28 has a threaded bore 40 (shown in phantom outline) defined therethough and is mounted to the second arm portion 26 in threaded engagement with the threads 38 of the shaft 24,26 such that the weight 28 moves towards and away from the body portion 22 upon rotation of the weight 28 relative to the shaft 24,26.

The cap 30 has a threaded bore 39A and is in threaded engagement with arm end 26A, so as to preclude removal of the weight 28 from the shaft 24,26 when the cap 30 is engaged. The cap is colored orange, for high visibility, to provide a strong indication to the angler of movement.

The clip 32 is substantially U-shaped, having two arms 42,44 merging into a base 46. The clip 32 is secured by one arm 42 to arm end 24A and is manually manipulable between a first configuration, shown in phantom in FIG. 3, whereat the other arm 44 is spaced from arm end 24A, and a second configuration, shown in blackline in FIG. 3, whereat the other arm 44 is in contact with the arm end 24A to define a closed loop. The clip 32 is biased for movement towards its first configuration.

The sleeve 34 is constructed of rubber and is mounted about the first arm portion 24 for manual manipulation between a first position, relatively proximal to the body portion 22 and shown in blackline in FIG. 3, and a second position relatively distal to the body portion 22 and shown in phantom outline in FIG. 3. The sleeve 34 is adapted such that, when the clip 32 is in its second configuration, the sleeve 34 can be moved from its first position to its second position whereat it restrains the clip 32 against movement towards its first configuration.

The bobber 20 of the preferred embodiment can be used in one of three distinct modes.

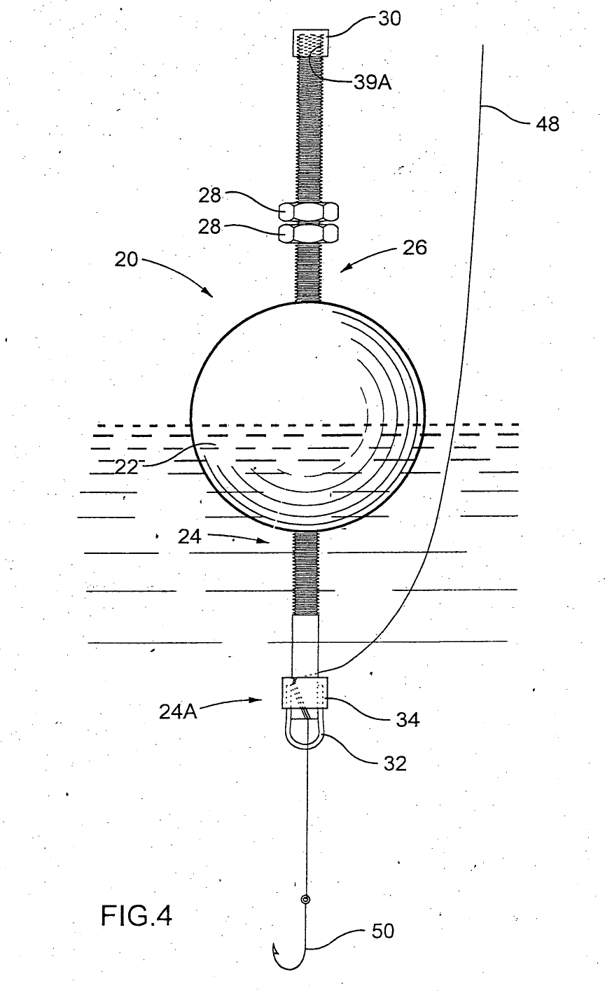

The bobber 20 is shown in the first mode of use in FIG. 4. In this mode, a fishing line 48 terminating in a hook 50 is caused to extend through the loop formed by the clip 32 and wrap around the end 24A of the first arm portion, in engagement with notch 43, and is captured in such arrangement by the sleeve 34.

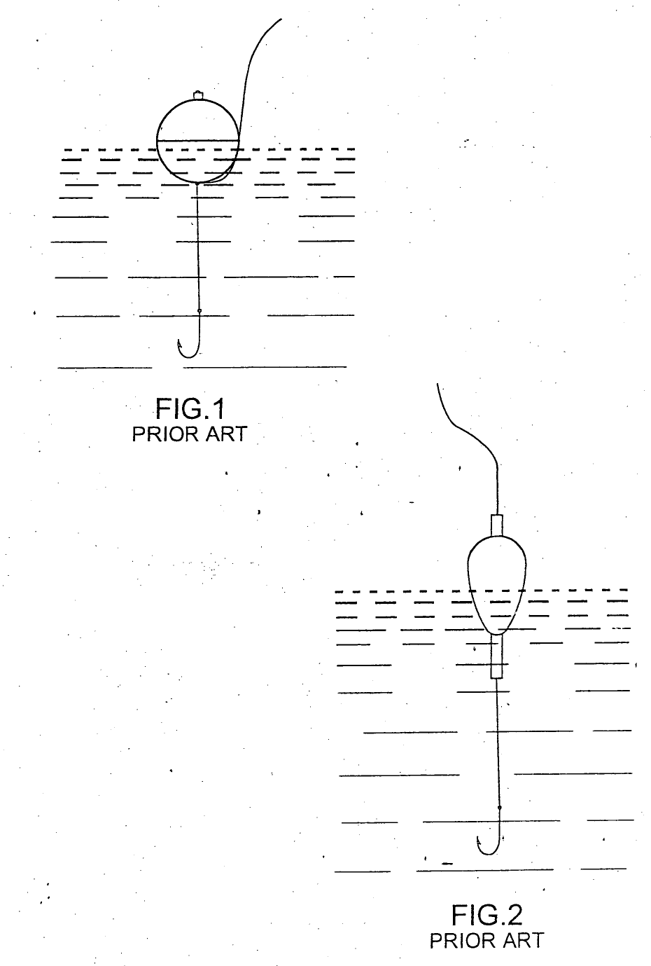

In this mode, the mass of the hook or bait set at the end of the line 48 causes the bobber 20 to sit in the water with the shaft 24,26 extending vertically and the hook 50 suspended by the line 48 a user-selectable depth beneath the body portion 22. It will be evident to persons of ordinary skill in the art that, in this mode, the clip 32 and sleeve 34 define line engaging means for securing said fishing line 48 to the body portion 22, and the bobber 20 functions similar to the prior art bobber shown in FIG. 1. It will also be readily evident to persons of ordinary skill in the art that, while only a hook 50 is shown, for clarity, the line 48 may be fitted with accessories. For example, the hook may be baited, or may form part of a lure. Sinkers may also be secured to the line. Yet further, it should be understood that whereas a weight 28 is shown in FIG. 4, it may be necessary to remove the weight, if the mass of the hook and bait or lure and optional sinker is not otherwise sufficient to cause the bobber 20 to assume the vertical orientation. The mass associated with the bobber 20 permits same to be cast relatively long distances.

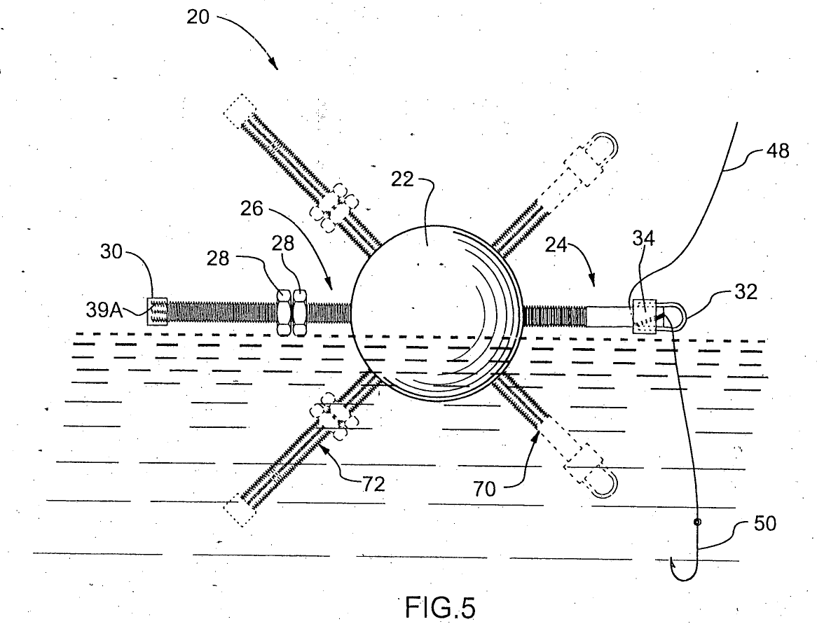

The bobber 20 is shown in the second mode of use in FIG. 5. In this arrangement, the clip 32 and sleeve 34 again define line engaging means for securing said fishing line 48 to the body portion 22 such that, in the absence of external forces, the hook 50 is suspended by the line 48 a user-selectable depth beneath the body portion 22. However, in this mode of use, the shaft 24,26 and the weight 28 define means for adjusting the centre of gravity of said fishing bobber 20 such that, in use and in the absence of external forces, the fishing bobber 20 is balanced such that bobber 20 floats in the water with the arms 24,26 projecting substantially horizontally therefrom, as shown in blackline in FIG. 5. To achieve such balance, the shaft 24,26 is longitudinally adjusted with respect to the body portion 22 by rotation of the shaft 24,26 relative thereto, and one or more weights 28 are threaded onto the second arm 26 and positioned, so as to compensate for the weight of the hook/lure/bait/sinker.

This mode of use provides substantial advantage to the angler over prior art bobbers of the type shown in FIG. 1. When a fish takes the hook 50 and moves away from the bobber 20, applying tension to the line 48, the bobber 20 tips such that the first arm portion 24 extends downwardly from the body portion 22, providing a highly visible signal to the angler, as indicated by outline 70 in FIG. 5. In its initial movement with the hook, the fish meets only limited resistance, since it is merely causing the bobber 20 to tip in the water from a balanced position, and is not causing any water displacement. Thus, the attentive angler is provided an opportunity to set the hook 50 even before the fish senses any line resistance. When the fish releases tension from the line, by taking the hook and swimming towards the bobber 20, the fishing bobber 20 tips under the weight of weight 28 such that the first arm portion 24 extends upwardly from the body portion, as indicated by outline 72 in FIG. 5. This also provides the angler an opportunity to set the hook. When a fish takes the hook, and travels in an arc around the bobber, the bobber 20 will spin in the water, providing yet a further opportunity to set the hook. Yet further, the sensitivity of this arrangement is so high that movement in the bobber 20 can be perceived even if the fish has not taken the hook. It is known, for example, for certain fish to, while sitting motionless in the water, inhale and exhale food a number of times prior to ingestion, and depending on the vigor of such activity, such activity may cause motion of the bobber 20, in which case the attentive angler may well be in a position to set the hook during such activity.

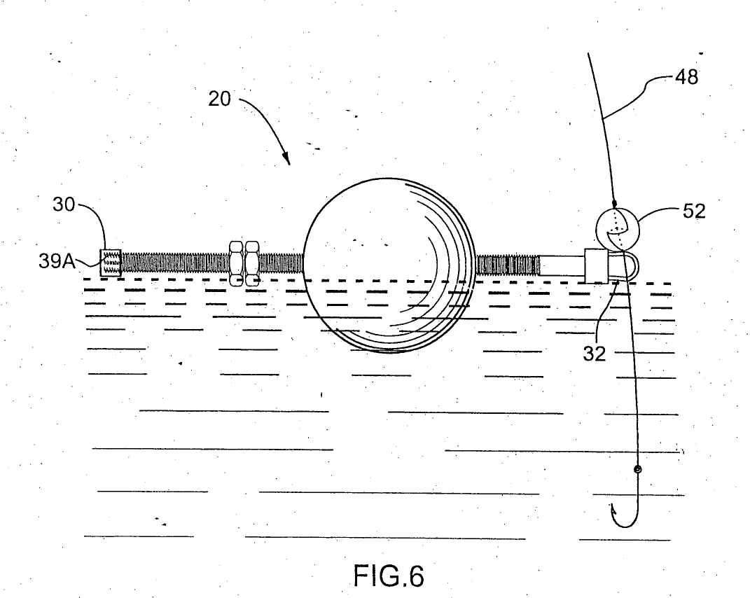

The bobber 20 is shown in the third mode of use in FIG. 6, wherein the bobber 20 is configured as a slip bobber: the fishing line 48 extends through the loop defined by the clip 32, and is not captured by the bobber.

In this mode, the bobber 20 has functionality similar to that described with reference to FIG. 5, but can slide along the fishing line 48 in the manner normally associated with slip bobber fishing but with greatly reduced line friction as compared to the slip bobber of FIG. 2, since the line 48 does not extend through the shaft but only through the clip 32. This provides great advantage in jig angling, since the lower friction between the line 48 and bobber 20 tends to reduce the motion of the bobber 20 towards the angler during jigging. Less motion means less casting (which can disturb fish). As well, the minimal friction to which the line is exposed allows even lightweight bait sets to descend by gravity in the water relatively quickly; this renders it easier for an angler to create the illusion of a darting baitfish by agitating the bait set.

As will readily be perceived by persons of ordinary skill in the art, the use to which the bobber 20 of the preferred embodiment is put can be easily switched between any of the three described modes, merely by changing the manner in which the line is caused to traverse the bobber. Advantageously, when changing from slip bobber to float bobber use and vice versa, the fishing line does not need to be cut, which is a drawback associated with conventional slip bobbers: the clip can merely be opened and the line withdrawn from or threaded into the bobber.

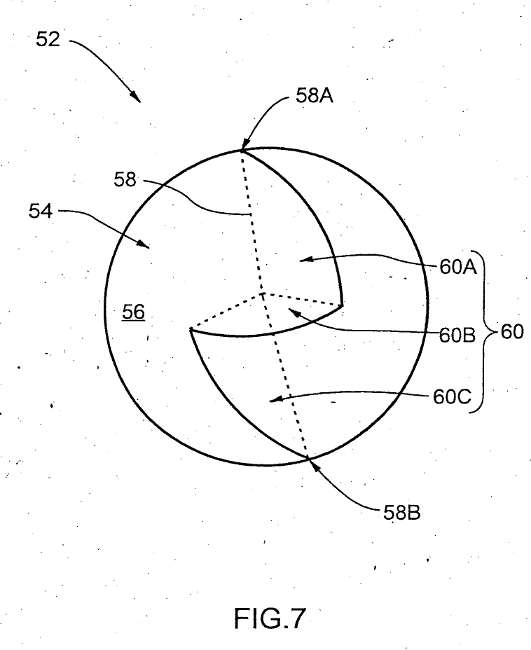

To take advantage of the ability of this bobber 20 to be reconfigured, the bobber 20 can be used in association with a stop bead 52 as shown in FIGS. 6,7. As best seen in FIG. 7, this stop bead 52 comprises a solid, spherical, resilient, specifically, elastic, body 54 larger in dimension than the loop defined by the clip 32. The body 54 has an outer surface 56 and defines a passage 58 and a jagged channel 60. The passage 58 extends through the body 54, is adapted to receive in throughpassing relation a fishing line 48, and terminates at opposites sides of the body 54 in passage terminii 58A,58B. The jagged channel 60 consists of three portions 60A,60B,60C, each defining a quadrant of a circle having a diameter equal to the diameter of the sphere 54, and extends between the passage terminii 58A,58B and from the outer surface 56 of the body 54 through to the passage 58. The advantage of this structure is that, upon elastic deformation of the body 54, a fishing line 48 received in the passage 58 in throughpassing relation can be withdrawn from the body 54 otherwise than by way of retraction of said line through said passage. Thus, an angler that is slip-bobber fishing with the fishing bobber 20 and stop bead 52 described herein can easily move to fixed bobber fishing or another form of fishing such as casting by opening the stop bead and withdrawing the line therefrom, and by opening the clip and withdrawing the line therefrom.

While but a single preferred embodiment of the fishing bobber is herein illustrated and described, various modifications thereto can be made without departing from the scope or spirit of the invention.

For example, whereas the float of the preferred embodiment is constructed of balsa wood, other arrangements, such as hollow plastic or foamed plastic bodies could readily be utilized, and shapes other than spherical shapes can be adopted.

Further, whereas the arm portions of the preferred embodiment form part of a shaft, the shaft need not extend through the float. For example, similar functionality could be obtained by providing separate arm parts, each threaded into the body portion.

Moreover, whereas a single weight is shown, multiple weights could readily be employed as desired. As well, the weights need not be threaded to the shaft; weights could, for example, be slidably mounted to the shaft.

The cap could take other forms, and could easily be omitted.

Further, arrangements could be provided for the clip and sleeve. The clip and sleeve, for example, could readily be replaced with a simple eyelet for receiving fishing line, for slip-bobber fishing, and, for fixed-bobber fishing, a retractable hook arrangement of the type found in conventional fixed bobbers.

As well, modifications can readily be made to the bead. For example, the jagged channel could easily be modified to follow a zig-zag path.

Accordingly, it should be understood that the scope of the present invention is to be limited only by the accompanying claims, purposively construed.

1. A fishing bobber for use with a fishing line terminating in a hook, said bobber having:
a body portion floatable in water;
a pair of elongate arm portions projecting from opposite sides of the body portion, said pair comprising a first arm portion to which said line is secured in use and a second arm portion,
means for adjusting the centre of gravity of said fishing bobber assembly such that, in use and in the absence of external forces,
the fishing bobber is balanced so as to float in the water with its arm portions projecting substantially horizontally, and
said hook is suspended by the line a user-selectable depth beneath the body portion,
whereby: when a fish applies tension to the line, the fishing bobber tips such that the first arm portion extends downwardly from the body portion; and when a fish releases tension from the line, the fishing bobber tips such that the first arm portion extends upwardly from the body portion.

2. A fishing bobber according to claim 1, wherein the means for adjusting the centre of gravity of said fishing bobber comprises at least one weight mountable to the second arm portion for movement towards and away from the body portion.

3. A fishing bobber according to claim 2, wherein the weight has a bore defined therethough and is mounted about the second arm portion.

4. A fishing bobber according to claim 3, wherein the second arm portion is externally threaded, the bore of the weight is threaded and the weight is movably mounted to the second arm portion by threaded engagement therewith.

5. A fishing bobber according to claim 1, wherein the first arm portion and the second arm portion are formed integrally as parts of an elongate shaft which extends through the body portion.

6. A fishing bobber according to claim 5, wherein the means for adjusting the centre of gravity of the fishing bobber comprises:
a thread defined externally on the elongate shaft in threaded engagement with the body portion to cause the shaft to move longitudinally with respect to the body portion upon rotation of the shaft.

7. A fishing bobber according to claim 6, further comprising an enlarged cap at the end of the second arm portion.

8. A fishing bobber according to claim 7, wherein the cap has a threaded portion in threaded engagement with the second arm portion.

9. A fishing bobber according to claim 1, further comprising:
a substantially U-shaped clip of the type having two arms merging into a base, the clip being secured by one arm to the end of the first arm portion and manually manipulable between
a first configuration, whereat the other arm is spaced from the end of the first arm portion; and
a second configuration, whereat the other arm is in contact with the end of the first arm portion to define a closed loop.

10. A fishing bobber according to claim 9, wherein the clip is biased for movement towards its first configuration.

11. A fishing bobber according to claim 9, further comprising a sleeve mounted about the first arm portion for manual manipulation between: a first position, relatively proximal to the body portion, and a second position, relatively distal to the body portion, the sleeve being adapted such that, when the clip is in the second configuration, the sleeve can be moved from its first position to its second position whereat it restrains the clip against movement towards its first configuration.

12. A stop bead for use with a fishing line, said stop bead comprising:
a solid, resilient body having an outer surface and defining
a passage extending through the body and adapted to receive in throughpassing relation said fishing line, the passage terminating at opposites sides of the body in passage terminii and
a jagged channel extending between the passage terminii and from the outer surface of the body through to the passage, thereby to permit, upon elastic deformation of the body, a fishing line received in the passage in throughpassing relation to be withdrawn from the body otherwise than by way of retraction of said line through said passage.

13. A stop bead according to claim 12, wherein
the body is a sphere having a diameter; and
the jagged channel consists of three portions each defining a quadrant of a circle having a diameter equal to the diameter of the sphere.

14. A stop bead according to claim 12, wherein the body is elastic.
